(19) United States
(12) Patent Application Publication
(10) Pub. No.: US 2004/0264469 A1
(43) Pub. Date: Dec. 30, 2004

(54) Efficient ATM cell switching method using ATM header having end destination

(76) Inventor: Jeong-Hoon Choi, Jeollanam-Do (KR)

Correspondence Address: FLESHNER & KIM, LLP, P.O. BOX 221200, CHANTILLY, VA, 20153, US

(21) Appl. No.: 10/821,182

(22) Filed: Apr. 9, 2004

(30) Foreign Application Priority Data
May 20, 2003 (KR) 31952/2003

(51) Int. Cl. H04L 12/28

(52) U.S. Cl. 370/395.1

(57) ABSTRACT

Efficient ATM (Asynchronous Transfer Mode) cell switching operations for establishing routing paths for ATM cells in an ATM-based network is achieved by using a newly created field indicating an end destination that is added to the front of an ATM cell header. Network delays and processing loads due to unnecessary ATM cell switching operations are reduced, and waste of VPI (Virtual Path Identifier) and VCI (Virtual Channel Identifier) resources is prevented. Such techniques may be applied to a network board requiring frequent ATM cell switching in an ATM-based mobile communication system.

### CROSS-REFERENCE TO RELATED APPLICATIONS

Pursuant to 35 U.S.C. § 119(a), this application claims the benefit of earlier filing date and right of priority to the following, the contents of which are hereby incorporated by reference herein in their entirety:

Korean Application No. 31952/2003, filed on May 20, 2003.

### BACKGROUND OF THE INVENTION

1. Field of the Invention

The present invention relates to asynchronous transfer mode (ATM) networking, and more particularly, to improved ATM cell switching by adding an end destination identifier in front of an ATM header.

2. Background of the Related Art

Asynchronous transfer mode (ATM) is a technology that was developed and is continuously being enhanced to meet the increasing demands for handling multimedia based applications (such as data, voice, video and images) in a high bandwidth and high speed network environment.

The basic idea behind ATM is to transmit (i.e., transport) all information in small, fixed size packets called ‘cells.’ The advantage of fixed sized cells is that more efficient switching can be performed and this results in very high rates of data transfer. The cells are 53 bytes long, of which 5 bytes are header and 48 bytes are payload. For simplicity, the ‘header’ may refer to the 4-byte portion that excludes the 1-byte HEC (header error control, also known as CRC (cyclic redundancy check)).

ATM is able to support various types of data by utilizing a particular type of protocol layer called the ATM adaptation layer (AAL). The AAL is used for cell construction and reception, as well as for the setup, operation, and tear down of virtual paths and circuits. User traffic information is routed through the network via such virtual paths or channels. There are four types of AALs (AAL1, AAL2, AAL3/4, AAL5) and each is designed to carry one type of traffic.

An ATM switch performs the relaying function of each cell through the network by assigning connection identifiers to each link of a connection. In an ATM switch, ATM cells are transported from an incoming logical channel to one or more outgoing logical channels. Here, a logical channel is indicated by a combination of two identities: the number of the physical link, and the identity of the channel, i.e., the Virtual Path Identifier/Virtual Channel Identifier (VPI/VCI) that allows cells belonging to the same connection to be distinguished. Also, ATM switches are used to buffer and relay cells as quickly as possible with minimal cell loss.

The general architecture of ATM switches is well-known in the art, and only those pertinent features will be discussed hereafter for the sake of clarity in explaining the present invention.

Referring to FIG. 1, in the related art structure, for processing a cell stream introduced into the network board, a particular path is allocated among a plurality of routing paths via a cell switching unit 1. Thereafter, when an ATM cell that has been assigned to a particular path requires processing, the cell is stored in Queue1 (10) of the corresponding path. Here, the cell switching unit 1 continues to receive cells being introduced and repeats its operation of allocating routing paths.

The cell processing unit 5 verifies the Queue status to see whether a cell exists or not, processes the cell by using the function defined, and stores the results in Queue2 (20). The cell stored in Queue2 (20) is selected together with Queue3 (30) (which is a memory for cells introduced into the network board) by an arbitration algorithm of the cell switching unit 1, and then, after going through another cell switching process, is sent to the destination upon receiving re-assignment of a final routing path.

The cell processing unit 5 performs one operation that is defined. If two or more operations are defined and performed, an equal number of ‘Queue 1—Cell Processing Unit—Queue 2’ sequence functions is required.

In an ATM network, there are instances when processing of an ATM cell is necessary. For example, such an instance is a change in cell type. To change the type (AAL type) (AAL: ATM Adaptation Layer) of a particular cell being introduced, the need for cell processing is checked by the cell switching unit 1, routing is done through the corresponding path, and the type of the cell is changed at the cell processing unit 5. The changed cell has a final routing path allocated thereto through another cell switching procedure.

Another example where processing is needed is the change in particular information (data) of an ATM cell payload that is defined in the network. This is where a cell having a particular VPI/VCI within the network is defined, and particular information of the payload is changed when a cell having the corresponding VPI/VCI is introduced.

In the related art structure, all cell streams introduced into the network board are stored in Queue3 (30), and the cell of the Queue that will process Queue3 (30) and Queue2 (20) (with a processed cell stored therein) by an appropriate arbitration algorithm is processed at the cell switching unit 1. At the cell switching unit 1, 4 bytes of the cell header (excluding the 1-byte HEC) having the VPI/VCI of the ATM cell stored therein are read in order to perform cell switching of Queue3 (30). Here, the cell switching unit 1, by checking its own VPI/VCI information arrangement, provides information for changing the VPI/VCI that has been read, into a new VPI/VCI and for routing.

For cell transmission to Queue1 (10) for PHY(0˜n), namely the physical layers which are the end destination within the network board, or loop back path and cell processing, the destination is determined by using routing information. The cell switching unit 1 first transmits (transports) 4 bytes of the cell header containing the changed VPI/VCI, and then after the 4^{th} byte, transmits the remaining 49 bytes (the 5^{th} through 53^{rd} bytes) stored in Queue3 (30).

The corresponding cell is allocated routing information of the cell processing unit 5 for cell processing. When a cell is stored in Queue1 (10), this is detected by the cell processing unit 5, and 53 bytes of the cell are read from Queue1 (10) for cell processing, cell processing is performed according to the function defined in the cell processing unit 5, and then stored in Queue2 (20). Here, the VPI/VCI of the cell can be changed, or the previous VPI/VCI can be maintained.

Thereafter, when a cell that should be processed in Queue2 (20) according to the arbitration algorithm is generated, the cell switching unit 1 reads a cell from Queue3 (30) (and as done in the switching operation), the 4 bytes of the cell header are read from Queue2 (20) to perform a change into a new VPI/VCI. After determining the final (end) destination using the routing information, the 4 bytes of cell header having the changed VPI/VCI is transmitted, and then the remaining 49 bytes (the 5^{th} through 53^{rd} bytes) stored in Queue2 (20) are transmitted.

Here, the cell switching unit 1 has information regarding VPI/VCI to be changed and routing information for all routing paths, in particular, for cells that are transferred to the cell processing unit 5, change information of routing to Queue1 (10) and routing information for transfer from Queue2 (20) to the final destination.

FIG. 2 shows a related art method of an ATM cell stream routing procedure depicted as a flow chart.

First, the cell switching unit 1 selects, from Queue1 (10) having stored therein all cell streams introduced into the subscriber (network) board, and from Queue2 (20) having stored therein cells that have been processed, a particular cell to be switched by using a certain bus arbitration algorithm (S101).

Also, the 4-byte cell header having VPI/VCI information of the selected cell included therein is read and converted into a new VPI/VCI by using an internal routing information table, and the corresponding cell is switched upon determining the final destination (S102).

Then, it is checked whether the processed cell requires processing (S103), and the cell is transferred to the final destination if no processing is required (S104), while, if cell processing is required, the cell is stored into Queue3 (30) and processed through the cell processing unit 5 (S105).

Regarding the transfer of the cell to its final destination and storing into Queue3 (30), after initially transferring the 4-byte header of the cell containing the changed VPI/VCI information, the 49 bytes (from the 5^{th} byte to the 53^{rd} byte) are then transferred.

As such, the cell processing unit 5 reads the 53 bytes of the cell from Queue3 (30), processes the corresponding cell according to certain operations, and then stores the cell in Queue2 (20). Here, the VPI/VCI of the processed cell may be changed (converted) or the previous VPI/VCI may be maintained.

However, the related art has some problems and disadvantages. In the related art, for a single ATM cell to be processed, two types of routing information, namely, the routing information to Queue1 (10) and the routing information from Queue2 (20) to the final (end) destination are required. Thus, inefficiencies are created in the ATM network having limited VPI/VCI resources, and the corresponding algorithm in resource management is complicated.

Also, in the repetitive cell switching for Queue2 (20) to the end destination, delays are created in the overall network for the corresponding cell due to the operation is for switching the cell header (4 byte, excluding the 1-byte HEC) having VPI/VCI information stored therein. Thus, the processing load at the cell switching unit 1 and the memory size for storing VPI/VCI routing information need to be made twice as large, as each ATM cell requires separate processing of the two types of routing information.

### SUMMARY OF THE INVENTION

Accordingly, the present invention addresses at least the above-identified problems of the related art.

An object of the present invention is to provide efficient ATM (Asynchronous Transfer Mode) cell switching operations for establishing routing paths for ATM cells in an ATM-based network by using a newly created field indicating an end destination that is added to the front of an ATM cell header.

To achieve the above objective, the present invention provides a method of switching an ATM cell by adding an information field before the header portion, processing the ATM cell having a total of more than 53 bytes, and forwarding the ATM cell after the information field is removed.

Namely, the present invention performs cell switching on a received ATM cell, adds routing information in front of a header of the ATM cell that has been switched, and forwards the ATM cell according to the added routing information without any further cell switching.

A cell switching unit having appropriate hardware and/or software can be used to add the routing information for each ATM cell. The ATM cell format used during cell switching comprises a 48-byte payload; a 5-byte header in front of the payload; and a 1-byte information field in front of the header, the information field containing an end destination for the payload.

Namely, the cell switching unit only needs to have a one virtual path identifier/virtual channel identifier (VPI/VCI) and one type of routing information for any received ATM cell.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory, and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing an exemplary structure for handling the switching of an ATM cell according to the related art;

FIG. 2 shows a method of ATM cell stream routing procedure according to the related art;

FIG. 3 is a diagram showing an exemplary structure for handling the switching of an ATM cell according to the present invention;

FIG. 4 shows a method of ATM cell stream routing procedure according to the present invention;

FIG. 5 is a diagram showing a user-node (user-network) interface (UNI) ATM cell format structure with an end destination field added thereto according to the present invention; and

FIG. 6 is a diagram showing an exemplary implementation of the present invention for a particular type of a CDMA 2000 1x EV-DO system.

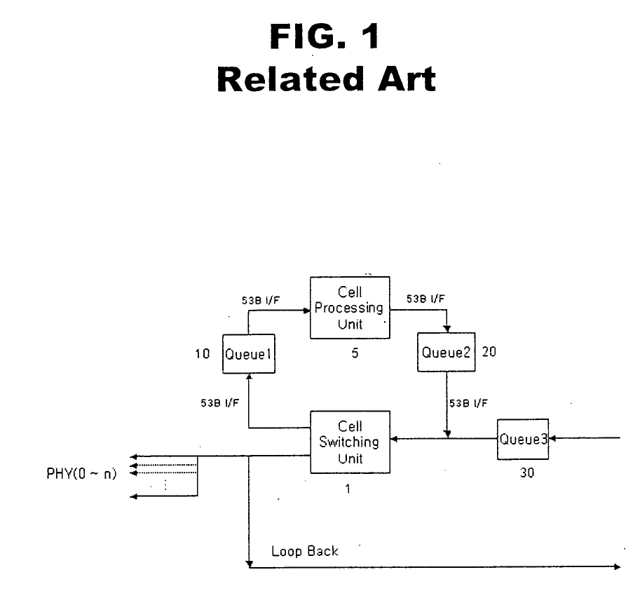

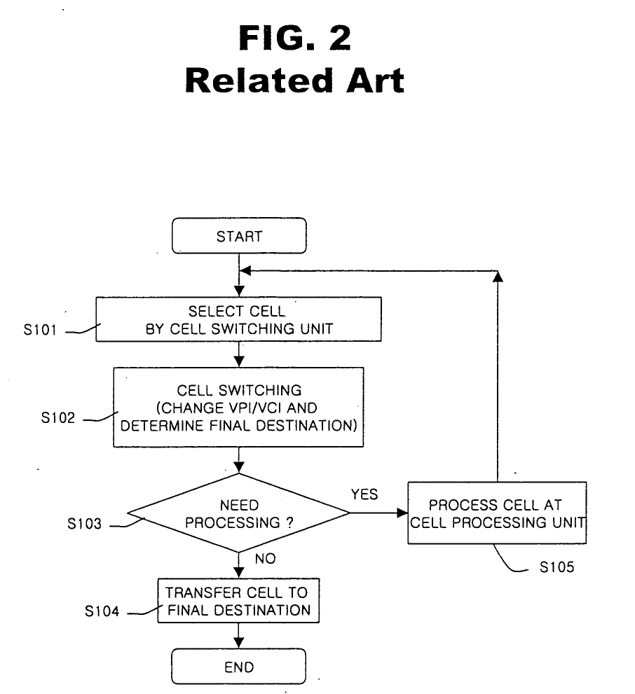

### DETAILED DESCRIPTION OF THE INVENTION

Reference will now be made in detail to the preferred embodiments of the present invention, examples of which are illustrated in the accompanying drawings.

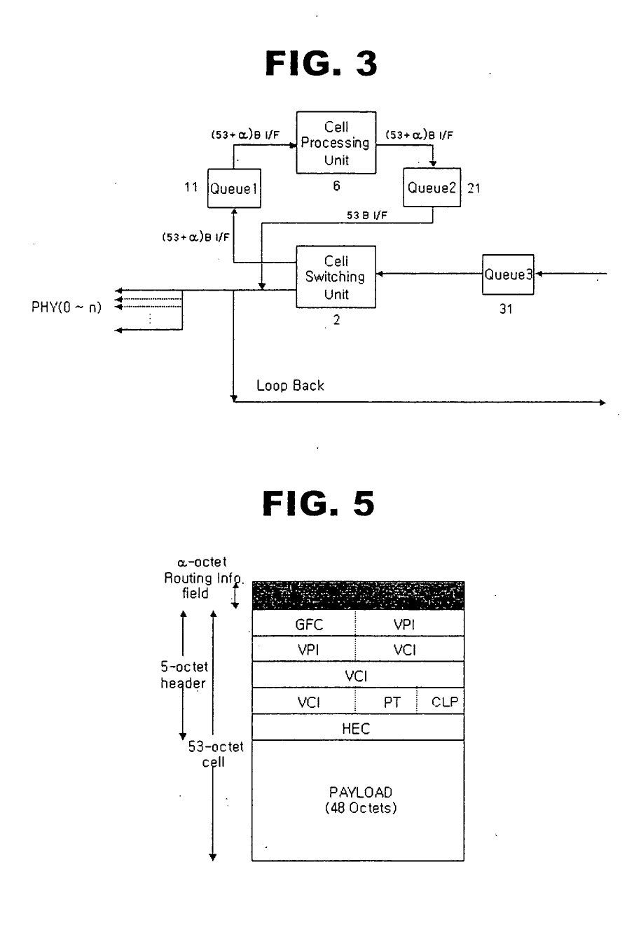

As shown in FIG. 3, the present invention structure is different than the related art structure in that the procedures in re-assigning the final routing path from Queue2 have been removed.

To process the cell stream introduced into the network board, a particular path of the plurality of routing paths is allocated by the cell switching unit 2 of FIG. 3, and then, when processing of the ATM cell assigned to that path is necessary, the cell is stored in the corresponding Queue1 (11). A cell to be routed to the final destination without the need for processing is transmitted over the routing path allocated by the cell switching unit 2.

Here, the cell switching unit 2 receives ATM cells being continuously introduced and repeats the operation of allocating routing paths. For the cells being routed to Queue1 (11), they are stored upon removal of the final routing path (e.g., end destination) information according to the related art, but in the present invention, such routing information (e.g., end destination) is added to a front portion of each cell header and then stored in Queue1 (11).

The cell processing unit 6 checks the status of Queue1 (11) to see whether or not a cell exists, and reads each cell having routing information added thereto, and processes the remaining ATM cell excluding the routing information by using the defined functions. Then, routing information (e.g., end destination) is added to the front portion of the processed cell header and stored in Queue2 (21). The cell processing unit 6 repeats these steps accordingly.

The cell stored in Queue2 (21), together with Queue3 (31) (which is a memory for cells introduced into the network board), are selected by the arbitration algorithm of the cell switching unit 2. Then, without another cell switching procedure for receiving re-assignment of the final routing path as in the related art, the routing information (e.g., end destination) added to each cell is monitored, the final routing information is checked, and the ATM cell (excluding the end destination field) is transmitted to the final (end) destination.

The cell processing unit 6 performs one operation that is defined. If two or more operations are defined and performed, an equal number of ‘Queue 1—Cell processing unit—Queue 2’ sequence of functions are required.

In an ATM network, there are instances when processing of an ATM cell is necessary. For example, such an instance is a change in cell type. To change the type (AAL type) of a particular cell being introduced, the need for cell processing is checked by the cell switching unit 2, routing is done trough the corresponding path, and the type of the cell is changed at the cell processing unit 6. The changed cell has a final routing path allocated thereto through cell switching again.

Another example where processing is needed is the change in particular information (data) of an ATM cell payload that is defined in the network. This is where a cell having a particular VPI/VCI within the network is defined, and particular information of the payload is changed when a cell having the corresponding VPI/VCI is introduced.

In the structure of the present invention, all cell streams introduced into the network board are stored in Queue3 (31), and the cell of the Queue that will process Queue3 (31) and Queue2 (21) (with a processed cell stored therein) by an appropriate arbitration algorithm is processed at the cell switching unit 2. At the cell switching unit 2, 4 bytes of the cell header (having the VPI/VCI of the ATM cell stored therein) is read in order to perform cell switching of Queue3 (31). Here, the cell switching unit 2, by checking its own VPI/VCI information arrangement, provides information for changing the VPI/VCI that has been read, into a new VPI/VCI and for routing.

For cell transmission to PHY(0˜n) (which is the end destination within the network board) or loop back path, the destination is determined by using routing information. The cell switching unit 2 first transmits 4 bytes of the cell header containing the changed VPI/VCI, and then after the 4^{th} byte, transmits 49 bytes (the 5^{th} through 53^{rd} bytes) stored in Queue3 (31). In contrast, for cell transmission to Queue1 (11) for cell processing, routing information is used to determine a path to Queue1 (11), and in order to preserve the routing information of the end destination that may be lost when the cell is stored in Queue1 (11), an α byte is added to the front of the first header of the ATM cell and routing information of the end destination is inserted into that field.

Accordingly, the cell switching unit 2 first transmits the α byte to Queue1 (11). Then the 4-byte cell header containing the changed VPI/VCI therein is transmitted, and then after the 4^{th} byte, 49 bytes (the 5^{th} through 53^{rd} bytes) stored in Queue3 (31) are transmitted. Namely, in contrast to the related art, which transmits 53 bytes (which is one unit of an ATM cell), the present invention transmits ATM cells of (53+α) bytes for the processing and routing of ATM cells.

The corresponding cell is allocated routing information of the cell processing unit 6 for cell processing. When a cell is stored in Queue1 (11), this is detected at the cell processing unit 6, and (53+α) bytes of the cell are read from Queue1 (11) for cell processing, and for the ATM cell 53 bytes (excluding the routing information field of the α byte), cell processing is performed according to the function defined in the cell processing unit 6. A α byte is added to a front portion of the re-processed cell, and then stored in Queue2 (21). Here, the VPI/VCI of the cell can be changed, or the previous VPI/VCI can be maintained.

Thereafter, in the related art, when a cell that should be processed in Queue2 (20) according to the arbitration algorithm is generated, the cell switching unit 1 reads a cell from Queue3 (30) and performed switching for routing to the end destination. However, in the present invention, the routing information of the end destination of the α byte that was initially stored in Queue2 (21) when VPI./VCI and Routing information were switched at the cell switching unit 2, is first read and then the final routing path is determined. Then, the 53 bytes of the ATM cell having the α byte excluded therefrom, are transmitted to the end destination without any re-switching.

Here, in the related art, the cell switching unit 1 has information regarding VPI/VCI to be changed and routing information for all routing paths. Namely, for cells that are transferred to the cell processing unit 5, VPI/VCI change information of routing to Queue1 (10) and routing information for transfer from Queue2 (20) to the final destination are required. However, in the present invention, the cell switching unit 2 only needs to have a single VPI/VCI and routing information for any cell introduced from Queue3 (31). The cell switching unit 2 of the present invention can have appropriate hardware and/or software for adding the routing information for each ARM cell.

In contrast to the related art requiring the processing of two types of routing information for one ATM cell, namely, routing information to Queue1 and routing information from Queue2 to the end destination, the present invention adds a routing information field of an α byte for interfacing (I/F) such that an ATM network having limited VPI/VCI resources can be effectively operated, and the corresponding algorithm in resource management can be simplified.

Also, repetitive cell switching process for Queue2 to end destination is removed, by storing in a α byte the final routing information generated when initial switching is performed, and thus the creation of delays during cell switching is prevented to reduce overall delay in the network. The processing load and the memory size required for storing VPI/VCI routing information are relatively smaller than those of the related art.

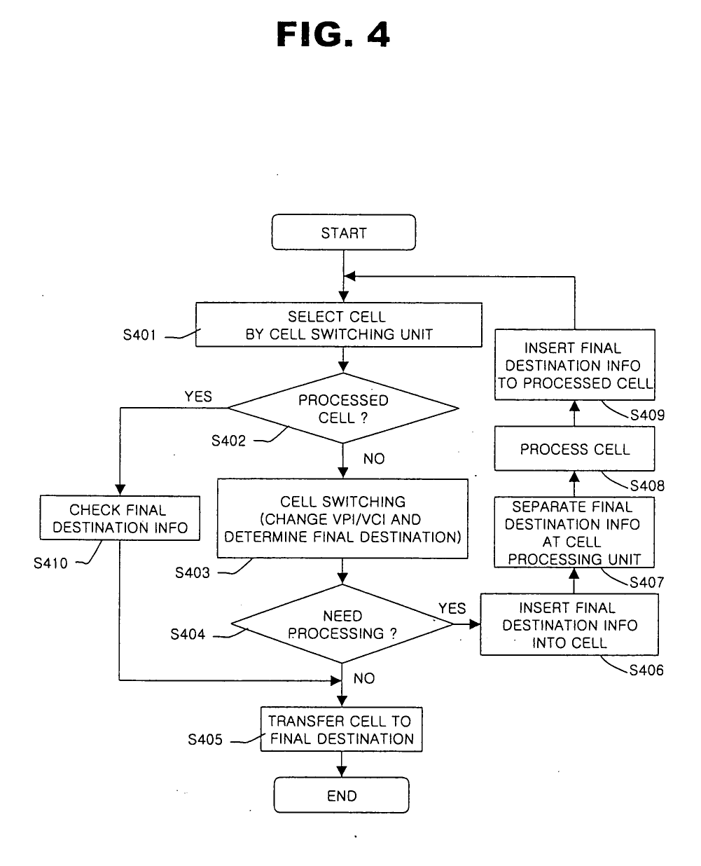

FIG. 4 shows a method of ATM cell stream routing procedure according to the present invention.

Referring to FIG. 4, the cell switching unit 2 selects from Queue1 (11) and Queue2 (21), a particular cell to be routed using a certain bus arbitration algorithm. (S401).

Also, if the selected cell is a cell that is stored in Queue1 (11), the VPI/VCI of the corresponding cell is changes upon switching and the final destination is determined (S402,403).

After that, it is checked as to whether the corresponding cell requires processing by referring to the VPI/VCI information of the switched cell (S404), and if no processing is required, the cell is transferred to the determined final destination (S405).

But, if cell processing is required, a routing data field is added to the corresponding cell, the determined final destination is inserted into the routing data field, and the cell having the routing data field added thereto is stored in Queue3 (31) (S406).

Then, the cell processing unit 6 separates the routing data field from the cell stored in Queue3 (31) (S407), the cell having the routing data field separated therefrom is processed according to an appropriate function (S408), and the processed cell is stored in Queue2 (21) after the routing data field is added again to the processed cell (S409).

Thereafter, the cell switching unit 2 selects a cell stored in Queue2 (21) according to a bus arbitration algorithm (S401), and checks the final destination information that was inserted into the routing data field of the selected cell (S402, S410), and transfers the cell to the final destination (S405).

FIG. 5 shows an example of a user-node (user-network) interface (UNI) ATM cell format structure with a routing information (e.g., end destination) field added thereto according to the present invention.

Namely, FIG. 3 shows an ATM cell including a 5-byte (octet) header and a 48-byte payload. A α-byte (octet) routing information field is added in front of the header to thus form an ATM cell having a total of (53+α) bytes. As in the related art, the header comprises a 4-bit GFC (Generic Flow Control), an 8-bit VPI (Virtual Path Identifier), a 16-bit VCI (Virtual Channel Identifier), a 2-bit PT (Payload Type), a 2-bit CLP (Cell Loss Priority), and a 16-bit HEC (Header Error Control), also known as CRC (cyclic redundancy check).

Additionally, the present invention can be applied to various types of mobile communication systems, but in particular, to an ALPA-I(A)/LICA-I(A) structure that performs ML type change functions of an ATM cell for a CDMA 2000 1x EV-DO system.

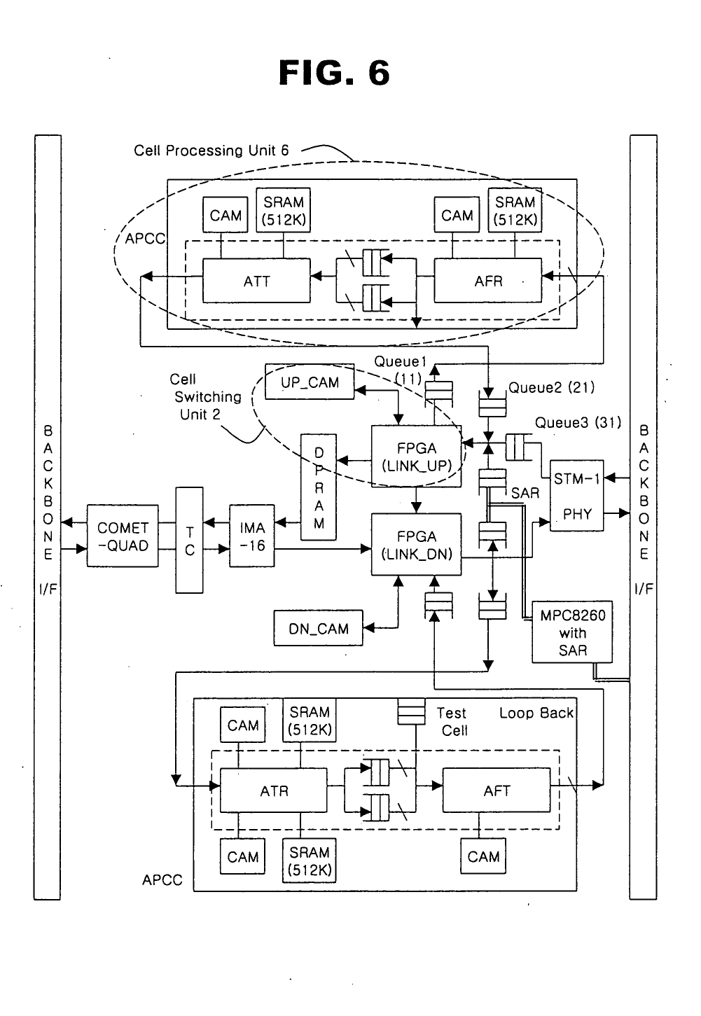

FIG. 6 is an ALPA-A block diagram showing an overall structure with a cell processing unit for processing cells, a cell switching unit 2 for transmitting cells to a end destination, and three Queues (11, 21, 31). The cell switching unit 2 of ALPA-A performs the function of changing between AAL5 and AAL2.

In FIG. 6, the module called APCC including the ATT and AFR blocks is equivalent to the cell processing unit 6 of the present invention for processing cells. The FPGA(LINK_UP) and UP_CAM are the cell switching unit 2 of the present invention for performing cell routing. The Queues 1, 2, and 3 connected between various elements are cell memory locations.

In particular, the FPGA(LINK_UP) of the cell switching unit 2 is the portion that performs the arbitration algorithm functions for selecting the cells stored in Queue 2 and Queue 3, and the read/write functions for the cell of (53+α) bytes. The UP_CAM is the portion that performs cell switching for the new VPI/VCI of a newly inputted cell and allocation of routing information.

In summary, the present invention provides a method for reducing overall network delays and efficient management of ATM resources, the method comprising: adding an α Byte of routing information to a front portion of an ATM cell header when processing a cell having end destination information, so that the destination information is not lost, allowing interfacing between each network element to perform cell processing and routing operations with a single cell switching operation.

Also, the present invention provides a method of switching an asynchronous transfer mode (ATM) cell having a payload portion and a header portion comprising: adding an information field before the header portion of the ATM cell; processing the ATM cell having a total of more than 53 bytes; and forwarding the ATM cell after the information field is removed.

Additionally, the present invention provides a method of processing an asynchronous transfer mode (ATM) cell comprising: performing cell switching on a received ATM cell; adding routing information in front of a header of the ATM cell that has been switched; and forwarding the ATM cell according to the added routing information without any further cell switching.

Moreover, the present invention provides an asynchronous transfer mode (ATM) cell switching system comprising: a first memory to receive and store an ATM cell to be handled; a cell switching unit to receive the ATM cell stored in the first memory, and to assign an appropriate path for the ATM cell to be forwarded to; and a cell processor to receive and process the ATM cell from the cell switching unit, and to output the ATM cell without going through the cell switching unit.

Here, the cell processor comprises: a second memory to receive and store the ATM cell having the appropriate path assigned thereto from the cell switching unit; a cell processing unit to receive the ATM cell stored in the second memory, and to process the ATM cell; and a third memory to receive and store the ATM cell processed by the cell processing unit, and to output the ATM cell without going through the cell switching unit.

Furthermore, the present invention provides an asynchronous transfer mode (ATM) cell format used during cell switching comprising: a payload; a header in front of the payload; and an information field in front of the header, the information field containing an end destination for the payload. Here, the information field is 1 byte, the payload is 48 bytes and the header is 5 bytes.

The foregoing embodiments are merely exemplary and are not to be construed as limiting the present invention. The present teachings can be readily applied to other types of methods and apparatuses. The description of the present invention is intended to be illustrative, and not to limit the scope of the claims. Many alternatives, modifications, and variations will be apparent to those skilled in the art.

What is claimed is:

1. A method for reducing overall network delays and efficient management of ATM resources, the method comprising:
adding an α Byte of routing information to a front portion of an ATM cell header when processing a cell having end destination information, so that the destination information is not lost, allowing interfacing between each network element to perform cell processing and routing operations with a single cell switching operation.

2. A method of switching an asynchronous transfer mode (ATM) cell having a payload portion and a header portion comprising:
adding an information field before the header portion of the ATM cell;
processing the ATM cell having a total of more than 53 bytes; and
forwarding the ATM cell after the information field is removed.

3. The method of claim 2, wherein the ATM cell during processing has (53+α) bytes, and α is a size of the information field.

4. The method of claim 3, wherein information regarding an end destination of the ATM cell is included in the information field.

5. A method of processing an asynchronous transfer mode (ATM) cell comprising:
performing cell switching on a received ATM cell;
adding routing information in front of a header of the ATM cell that has been switched; and
forwarding the ATM cell according to the added routing information without any further cell switching.

6. The method of claim 5, wherein the received ATM cell has a size of 53 bytes.

7. The method of claim 6, wherein the added routing information has a size of 1 byte.

8. The method of claim 7, wherein the forwarded ATM cell has a size of 53 bytes, after the 1 byte routing information has been removed.

9. The method of claim 5, further including a step of processing the ATM cell before forwarding.

10. The method of claim 9, wherein the processing step comprises a changing of an ATM adaptation layer (AAL) type or a changing of payload information.

11. An asynchronous transfer mode (ATM) cell switching system comprising:
a first memory to receive and store an ATM cell to be handled;
a cell switching unit to receive the ATM cell stored in the first memory, and to assign an appropriate path for the ATM cell to be forwarded to; and
a cell processor to receive and process the ATM cell from the cell switching unit, and to output the ATM cell without going through the cell switching unit.

12. The system of claim 11, wherein the cell processor comprises:
a second memory to receive and store the ATM cell having the appropriate path assigned thereto from the cell switching unit;
a cell processing unit to receive the ATM cell stored in the second memory, and to process the ATM cell; and
a third memory to receive and store the ATM cell processed by the cell processing unit, and to output the ATM cell without going through the cell switching unit.

13. The system of claim 12, wherein the cell switching unit provides an output to a physical layer and to a loop back, or an output for further processing.

14. The system of claim 13, wherein the cell switching unit adds an end destination field in front of a header of the ATM cell.

15. The system of claim 14, wherein the added end destination field is maintained as the ATM cell passes through the second memory, the cell processing unit, and the third memory.

16. The system of claim 15, wherein the third memory outputs directly to a physical layer or to a loop back in accordance with the end destination field.

17. The system of claim 11, wherein the cell switching unit requires a one virtual path identifier/virtual channel identifier (VPI/VCI) and one type of routing information for any received ATM cell.

18. The system of claim 12, wherein the cell processing unit processes the received ATM cell by changing an ATM adaptation layer (AAL) type or by changing payload information.

19. An asynchronous transfer mode (ATM) cell format used during cell switching comprising:
a payload;
a header in front of the payload; and
an information field in front of the header, the information field containing an end destination for the payload.

20. The ATM cell format of claim 19, wherein the information field has a size of 1 byte.

21. The ATM cell format of claim 19, wherein the payload has a size of 48 bytes and the header has a size of 5 bytes.
